(19) United States
(12) Patent Application Publication
(10) Pub. No.: US 2014/0274356 A1
(43) Pub. Date: Sep. 18, 2014

(54) EXPANDABLE ONLINE CASINO GAME SYSTEM

(71) Applicant: Userjoy Technology Co., Ltd., (US)

(72) Inventor: Che Ming Chang, NEW TAIPEI CITY (TW)

(73) Assignee: USERJOY TECHNOLOGY CO., LTD., NEW TAIPEI CITY (TW)

(21) Appl. No.: 13/798,140

(22) Filed: Mar. 13, 2013

(51) Int. Cl. G07F 17/32

(52) U.S. Cl. CPC G07F 17/323
USPC 463/29; 463/42

(57) ABSTRACT

The expandable online casino game system contains a match server governing a number of game servers. The match server contains a room butler and a news agency. Each game server contains a storage module and a game module. The storage module contains a game list cache and a news cache. The game module contains a virtual lobby and a number of game rooms. The room butler manages the game list caches of all game servers, collects the game contents of opened game rooms, and controls the number of players of each game room. The news agency integrates the records of Jackpots and Big Wins for the players in each game room from the news cache of each game server, and constantly updates the news caches of all game servers. Each news cache in turn immediately notifies the virtual lobby and the game rooms in the same game server.

### (a) TECHNICAL FIELD OF THE INVENTION

The present invention is generally related to distributed game systems and more particular to a game system where game servers can be added dynamically and game information can be integrated.

### (b) DESCRIPTION OF THE PRIOR ART

The word “casino” is originated from Italian, originally meaning a small building where gambles are conducted. Nowadays, a casino refers to a grand and magnificent architecture where various amusements and games are provided.

Until recently, quite a number of nations have specific regions developed to accommodate casinos providing computer games, slots, baccarat, roulette, blackjack, Texas hold'em games, craps, etc.

With the advancement of digital electronics, casino game designers are allowed more room for their creativity, as computers have provided unprecedented flexibility, functions, and connectivity.

Most regulations require that gambling games can only be conducted at specific locations whereas non-opportunistic games can be run in public or over the Internet. The amusement-only online casino games can vary greatly in terms of their contents. Usually online casino games can have by multiple players, thereby enhancing the games' value and amusement.

In order to accommodate a large number of players, these online casino games require servers of high capacity and performance. However, these servers are difficult to expand to meet the need of a continuously growing number of players.

### SUMMARY OF THE INVENTION

The present invention provides an expandable online casino game system adopting distributed game servers to handle players from all over the world. All game servers are connected to a match server administrating and managing the operation of all game rooms. The match server can also be expanded dynamically to functions other than online games.

The expandable online casino game system contains a match server and a number of game servers. The match server contains two modules: a room butler and a news agency.

Each game server contains two modules: a storage module and a game module. The storage module contains a game list cache and a news cache. The game module contains a virtual lobby and a number of game rooms.

The room butler manages the game list caches of all game servers, collects the game contents of opened game rooms, and controls the number of players of each game room. The news agency integrates the records of Jackpots and Big Wins for the players in each game room from the news cache of each game server, and constantly updates the news caches of all game servers. Each news cache in turn immediately notifies the virtual lobby and the game rooms in the same game server.

The room butler compiles the information about the games opened in the game servers and immediately notifies the game list caches of all game servers. When a player logins a game server, the player can search and choose a game he or she would like to participate, and then enters the chosen game's game room quickly. The player can freely enter or leave the virtual lobby and the game rooms of the game server.

When a game server is overloaded by a large number of players, an additional game server can be added immediately. The room butler and news agency of the match server can immediately provide all information to the additional game server, and the additional game server can interconnect with the existing game servers. This dynamic expansion capability of the present invention can meet unexpected player demands without affecting the ongoing games.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the architecture of the expandable online casino game system according to the present invention.

FIG. 2 is a schematic diagram showing the interaction between the room butler and various game servers of the expandable online casino game system according to the present invention.

FIG. 3 is a schematic diagram showing the interaction between the news agency and various game servers of the expandable online casino game system according to the present invention.

FIG. 4 is a flow diagram showing the operation of the expandable online casino game system according to the present invention.

FIG. 5 is a flow chart of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The expandable online casino game system mainly contains a match server functioning as a master governing the “game rooms” of all game servers in terms of usage conditions, distribution of players, expansion of game rooms, information exchange, and player authentication. The match server is capable of supporting multiple game servers and, as such, additional game servers can be dynamically added to accommodate newly joined players without affecting the overall operation and the currently online players.

As shown in FIG. 1, the expandable online casino game system contains a match server 100 and a number of game servers 10, 20, and 30. The match server 100 has ordinary computing and management capability and contains two modules: a room butler 101 and a news agency 102. Using a first game server 10 as example, it contains two modules: a storage module and a game module (both not numbered). The storage module contains a game list cache 11 and a news cache 12. The game module contains a virtual lobby 13 and a number of game rooms 1, 2, 3, etc. (for simplicity, they are jointly referred to as game rooms G).

The virtual lobby 13 provides an entry screen for players, manages player authentication, and offers game titles and contents for players to choose. Each game room G provides the specific game for multiple players to compete. Both the virtual lobby 13 and the game rooms G provide lists of highest scoring players and those of “Big Wins” so that players would feel full participation whether they are in the virtual lobby 13 of a game room G.

In the present embodiment, each game server 10, 20, or 30 has a virtual lobby 13 and three game rooms G. In room butler 101, these game rooms are numbered sequentially such as game room 1, 2, 3, . . . , 9, for management purpose.

The room butler 101 manages the game list caches 11 of all game servers 10, 20, and 30 (in the present embodiment, there are three game servers), collects the game contents of opened game rooms G, and controls the number of players (jointly referred to as P) of each game room G, as shown in FIG. 2. The news agency 102 on the other hand integrates the records of Jackpots and Big Wins for the players P in each game room G from the news cache 12 of each game server, and constantly updates the news caches 12 of all game servers. Each news cache 12 in turn immediately notifies the virtual lobby 13 and the game rooms G in the same game server, as shown in FIG. 3.

The game list cache 11 contains information about the titles and contents of the games run in the game rooms of a game server. This information is gathered and uploaded to the room butler 101 for inquiring and choosing. The news cache 12 keeps the records of Jackpots and Big Wins for the players Pin each game room G of a game server and uploads the records to the match server 100 for integration by the news agency 102. The room butler 101 and the news agency 102 immediately publish updated information.

As shown in FIG. 2, the room butler 101 compiles the information about the games opened in the game servers and immediately notifies the game list caches 11 of all game servers. When a player P logins a game server, the player P can search and choose a game he or she would like to participate, and then enters the chosen game's game room quickly. The player P can freely enter or leave the virtual lobby 13 and the game rooms G of the game server.

Whether the player P is in a game room G or in the virtual lobby 13, the player P can access the list of Big Wins, the number of currently participating players, and the list of players of highest Jackpots.

Each game server can open multiple game rooms G, and the number of game rooms G is not limited to three, as the present embodiment exemplifies. Each game room can allow concurrent access of hundreds or thousands of players. The capacity is completely determined by the performance of the game server.

When a game server 10, 20, or 30 is overloaded by a large number of players, a fourth game server 40 can be added immediately, as shown in FIG. 4. The room butler 101 and news agency 102 of the match server 100 can immediately provide all information to the fourth game server 40, and the fourth game server 40 can interconnect with the existing game servers 10, 20, and 30. This dynamic expansion capability of the present invention can meet unexpected player demands without affecting the ongoing games.

The operation of the expandable online casino game system is depicted in FIG. 5. As illustrated, when a player P accesses the expandable online casino game system, the player P is connected randomly to the virtual lobby 13 of a game server, say, 10. Then, in step A, the player P logins and then chooses a desirable game from the list provided by the game list cache 11 in step B. This choice is reported to the room butler 101 of the match server 100 by the game list cache 11. The room butler 101 determines if the player P is qualified for the game such as the player P's age and membership status, and then notifies the game server 10 in step C. If the player P passes the authentication, the player P is connected to the specified game room G in step D. If the game room G is in another game server, or the game room's number of players has reached an upper limit, the player P is notified to switch to another game room G having number of players lower than the threshold in another game server 20 or 30 in step E.

The players of highest Jackpots and Big Wins of each game are collected by the news agency 102 of the match server 100, and then published to the virtual lobbies 13 and game rooms G of all game servers. All players P can obtain this information from the virtual lobby 13 or the game room G where the player P is located.

The player P can leave the game room G and enter the virtual lobby 13 at any time. The player P then can pick a new game in the virtual lobby 13 or leave the system.

As described above, the expandable online casino game system of the present invention has the following advantages.

Firstly, a player distribution mechanism allows that players login to multiple game servers and the match server only compiles information from the game servers. The match server is offloaded whereas the game servers handle the games for all players.

Secondly, a switch mechanism allows that a player first login to a random game server and then can choose to switch to another game room and virtual lobby.

Thirdly, a dynamic expansion mechanism allows that, when a game server cannot anymore player, an additional game server can be added to handle new players.

Fourthly, an information broadcast mechanism allows synchronous information exchange. No matter which virtual lobby a player is located at, the same information (e.g., the Jackpots) is delivered instantly. As such, a player does not feel isolated from other players.

Fifthly, the room butler can automatically distribute players to different game rooms.

Sixthly, players from various physical locations can compete together in a same game.

Seventhly, a player is not required to understand the system architecture, and players are automatically distributed to different virtual lobbies or game rooms.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An expandable online casino game system, comprising:
a plurality of game servers, each game server comprising a storage module and a game module where the storage module provides a game list cache and a news cache; and the game module provides a virtual lobby and at least a game room; and
a match server governing the game servers; the match server comprising a room butler and a news agency where the room butler manages the game list caches of all game servers, collects the game contents of opened game rooms, and controls the number of players of each game room; the news agency integrates the records of Jackpots and Big Wins for the players in each game room from the news cache of each game server, and constantly updates the news caches of all game servers; and each news cache in turn immediately notifies the virtual lobby and the game rooms in the same game server.

2. The expandable online casino game system according to claim 1, wherein each virtual lobby provides an entry screen for players, manages player authentication, offers game titles and contents for players to choose.

3. The expandable online casino game system according to claim 1, wherein each game room provides a game where at least a player participates.

4. The expandable online casino game system according to claim 1, wherein a player is capable of freely entering or leaving a virtual lobby or a game room of a game server.

5. The expandable online casino game system according to claim 1, wherein, when an additional game server is added, the room butler and news agency of the match server immediately provide all information to the additional game server.

6. The expandable online casino game system according to claim 1, wherein the room butler automatically picks a game server for a player's chosen game.
